(19) United States
(12) Patent Application Publication
(10) Pub. No.: US 2026/0254481 A1
(43) Pub. Date: Aug. 27, 2026

(54) POWER TRANSMISSION APPARATUS

(71) Applicant: NTT, Inc., Tokyo (JP)

(72) Inventor: Takanori WASHIRO, Tokyo (JP)

(21) Appl. No.: 18/853,536

(22) PCT Filed: Apr. 8, 2022
(86) PCT No.: PCT/JP2022/017384

§ 371 Date: Oct. 2, 2024

(51) Int. Cl. H02J 50/70; H02J 50/05

(52) U.S. Cl. CPC H02J 50/70; H02J 50/05

(57) ABSTRACT

An object of the present disclosure is to prevent emission of electric fields in a direction that does not contribute to power transmission.

Therefore, according to the present disclosure, there is provided a power transmission device that transmits power, the power transmission device including: an electric field antenna including a resonance unit that includes an electrode, a ground, and a primary coil connecting the electrode and the ground, and resonates at an output frequency of a power transmission/reception circuit for power transmission, and a power supply unit that includes a secondary coil magnetically coupled to the primary coil and electrically connected to the power transmission/reception circuit, the power supply unit being connected to the ground of the resonance unit and a ground of the power transmission/reception circuit.

### TECHNICAL FIELD

The present disclosure relates to a power transmission device.

### BACKGROUND ART

An electric field antenna and a magnetic field antenna using near field resonance are used for wireless power transmission and communication of a non-contact IC card because antennas facing each other at a short distance are strongly coupled and power can be transmitted with high efficiency. (Since the non-contact IC card does not include a battery, power required for communication is wirelessly transmitted together with data).

Non Patent Literature 1 discloses an antenna that performs wireless power transmission using electric fields. Since a shape of the antenna is symmetrical between a front surface and a back surface, electric fields are simultaneously emitted in both a front surface direction in which a counterpart for power transmission is placed and a back surface direction opposite to the front surface direction. The electric fields emitted in the back surface direction do not contribute to power transmission, and cause electromagnetic noise. As a result, a malfunction is caused in a nearby electronic device including the antenna itself. In addition, in a case where electric field waves emitted in the back surface direction are reflected by a metal plate or the like disposed on the antenna and the reflected electric field waves return to the antenna, an operation of the antenna is hindered.

Patent Literature 1 discloses an antenna that performs wireless power transmission and non-contact communication using magnetic fields. The antenna also has a symmetrical shape on a front surface and a back surface. Thus, magnetic fields are simultaneously emitted in both a front surface direction and a back surface direction. The magnetic fields emitted in a direction in which a counterpart for communication is not present cause a malfunction in a nearby electronic device including the antenna itself. In a case where there is a metal plate in the emitted magnetic fields, an eddy current that cancels out the magnetic fields flows through the metal plate, and heat is generated. Further, the magnetic fields are weakened by the eddy current, and as a result, communication performance of the antenna is deteriorated.

### CITATION LIST

### Non Patent Literature

Non Patent Literature 1:“Electric Field Resonant Antenna for Wireless Power Transfer Based on Infinitesimal Dipole” IEEE Wireless Power Transfer Conference (WPTC2021)

### Patent Literature

Patent Literature 1: JP 2008-288845 A

### SUMMARY OF INVENTION

### Technical Problem

As described above, since an antenna using near field resonance of electric fields or magnetic fields has high power transmission efficiency, the antenna is widely used for wireless power transmission and communication of a non-contact IC card. However, electric field waves or magnetic field waves for power transmission are emitted in both a front surface direction and a back surface direction of the antenna, and as a result, there is a problem in how to prevent emission of electric field waves or magnetic field waves in a direction that does not contribute to power transmission.

The present invention has been made to solve the above-described problem, and an object of the present invention is to prevent emission of electric fields in a direction that does not contribute to power transmission.

### Solution to Problem

In order to solve the above problem, the invention according to claim 1 provides a power transmission device that transmits power, the power transmission device including: an electric field antenna including a resonance unit that includes an electrode, a ground, and a primary coil connecting the electrode and the ground, and resonates at an output frequency of a power transmission/reception circuit for power transmission, and a power supply unit that includes a secondary coil magnetically coupled to the primary coil and electrically connected to the power transmission/reception circuit, the power supply unit being connected to the ground of the resonance unit and a ground of the power transmission/reception circuit.

### Advantageous Effects of Invention

As described above, according to the present invention, it is possible to prevent emission of electric fields in a direction that does not contribute to power transmission.

### BRIEF DESCRIPTION OF DRAWINGS

FIG. 1 is a diagram illustrating an example of an electric field antenna using near field resonance with high transmission efficiency at a short distance.

FIG. 2 is a diagram illustrating an example of a magnetic field antenna using near field resonance with high transmission efficiency at a short distance.

FIG. 3 is a diagram illustrating a structure of the electric field antenna using resonance.

FIG. 4 is a diagram illustrating an operation of the electric field antenna using resonance.

FIG. 5 is a diagram illustrating a structure and an operation of a new resonance unit according to the present embodiment.

FIG. 6 is a diagram illustrating a structure and an operation of a new resonance unit according to the present embodiment.

FIG. 7A is a plan view of a power transmission device according to a first embodiment.

FIG. 7B is a perspective view of a power transmission device according to a first embodiment.

FIG. 8A is a plan view of a power transmission device according to a technique as a premise for a second embodiment and subsequent embodiments.

FIG. 8B is a perspective view of a power transmission device according to a technique as a premise for a second embodiment and subsequent embodiments.

FIG. 9A is a plan view of a power transmission device according to a second embodiment.

FIG. 9B is a perspective view of a power transmission device according to a second embodiment.

FIG. 10A is a plan view of a power transmission device according to a third embodiment.

FIG. 10B is a perspective view of a power transmission device according to a third embodiment.

FIG. 11A is a plan view of a power transmission device according to a fourth embodiment.

FIG. 11B is a perspective view of a power transmission device according to a fourth embodiment.

FIG. 12 is a graph showing transmission efficiency in a technique as a premise for the second embodiment and subsequent embodiments, or transmission efficiency according to the fourth embodiment.

### DESCRIPTION OF EMBODIMENTS

### Specific Description of Development Technique

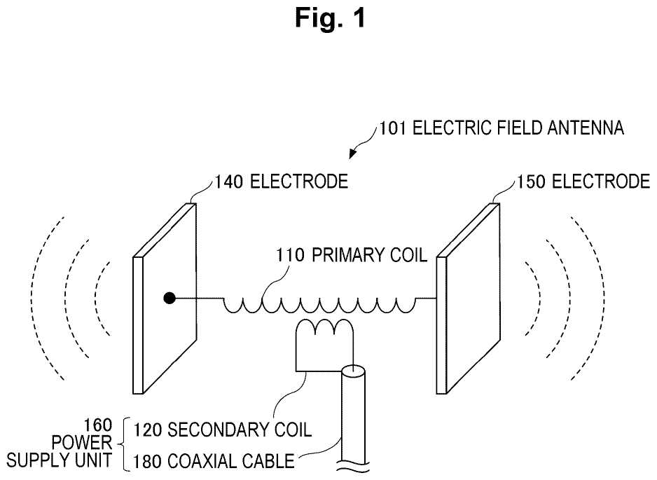

FIG. 1 is a diagram illustrating an example of an electric field antenna using near field resonance with high transmission efficiency at a short distance.

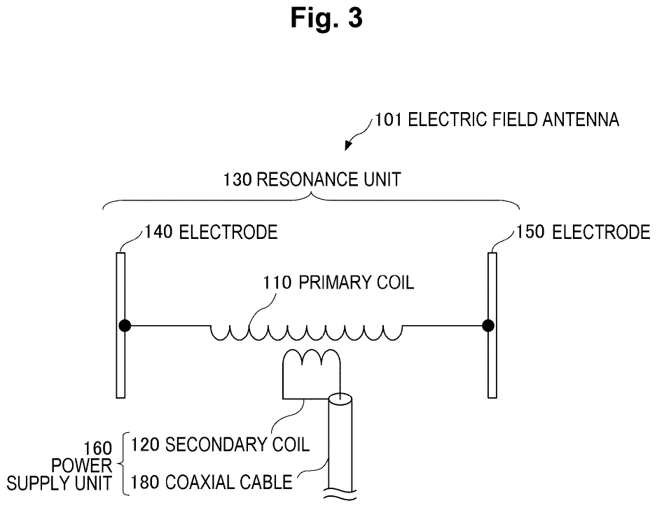

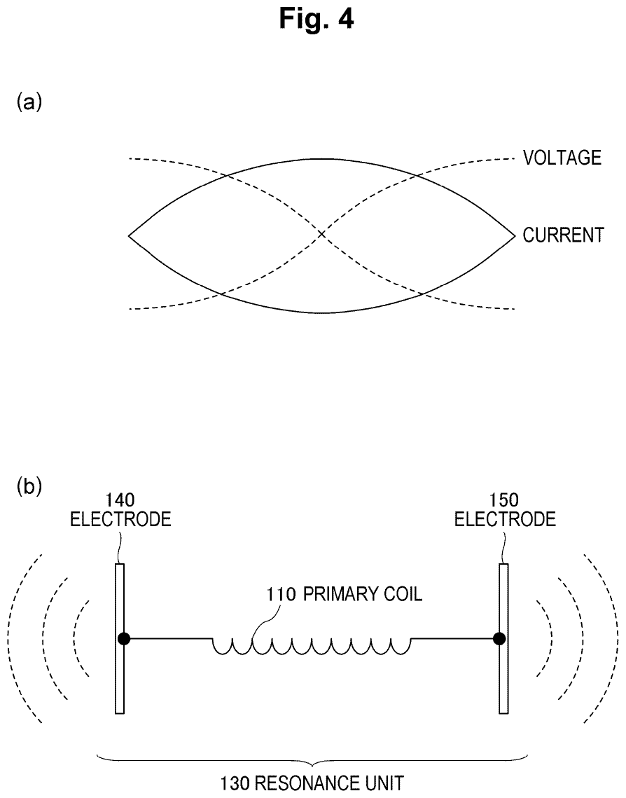

As illustrated in FIG. 1, in an electric field antenna 101, two electrodes 140 and 150 form a micro-electric dipole, and positive and negative charges accumulated on the electrodes 140 and 150 are alternately exchanged at a high frequency. Thereby, electric field waves are emitted in a front surface direction and a back surface direction (a right direction and a left direction on a paper surface). Note that a structure of the electric field antenna 101 will be described with reference to FIG. 3 and FIG. 4.

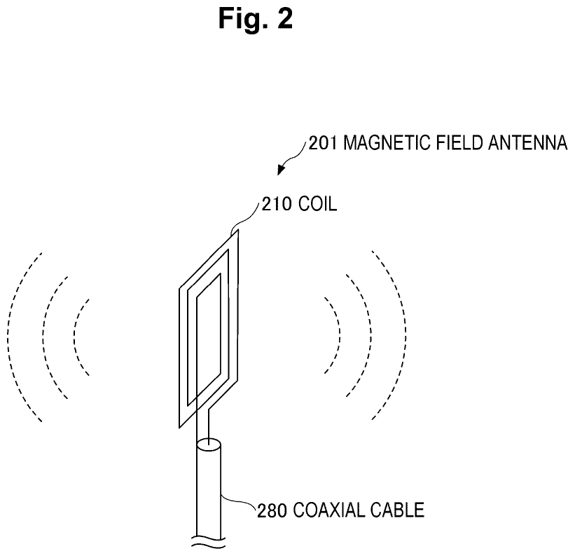

FIG. 2 is a diagram illustrating an example of a magnetic field antenna using near field resonance with high transmission efficiency at a short distance. A magnetic field antenna 201 of FIG. 2 emits magnetic field waves in a front surface direction and a back surface direction (a right direction and a left direction on a paper surface) by causing a high-frequency alternating current to flow through a coil 210.

In the electric field antenna 101 of FIG. 1, in a case where two antennas that resonate at the same frequency are disposed at a short distance, the antennas have strong electric field coupling and can transmit power with high efficiency. In addition, in the magnetic field antenna 201 of FIG. 2, in a case where two antennas that resonate at the same frequency are disposed at a short distance, the antennas have strong magnetic field coupling and can transmit power with high efficiency.

Next, a structure of the electric field antenna using resonance and an operation of the electric field antenna will be described with reference to FIG. 3 and FIG. 4. FIG. 3 is a diagram illustrating a structure of the electric field antenna using resonance. FIG. 4 is a diagram illustrating an operation of the electric field antenna using resonance.

The electric field antenna 101 includes a resonance unit 130 that resonates at a specific frequency, and a power supply unit 160 that inputs power to the resonance unit 130 or extracts power from the resonance unit 130 which resonates. The power supply unit 160 inputs and outputs power to and from the resonance unit 130 by a secondary coil 120 that is magnetically coupled to a primary coil 110 in the resonance unit 130. The power supply unit 160 includes a secondary coil 120 and a coaxial cable 180 electrically connected to the secondary coil 120.

When the resonance unit 130 resonates, standing waves of a voltage and a current corresponding to a ½ wavelength are generated in the resonance unit 130. FIG. 4(a) illustrates a distribution of the standing waves of the voltage and the current. The standing wave of the current flowing through the resonance unit 130 has a maximum amplitude at a center of the resonance unit 130, and the amplitude is 0 at both ends, that is, at positions of the electrodes 140 and 150. Further, the standing wave of the voltage has a maximum amplitude at the positions of the electrodes 140 and 150 at both ends of the resonance unit 130, and the amplitude is 0 (that is, the potential is 0) at the center of the resonance unit 130. When a high voltage is applied to the electrodes, as illustrated in FIG. 4(b), electric field waves are emitted from the left and right electrodes 140 and 150 toward the air.

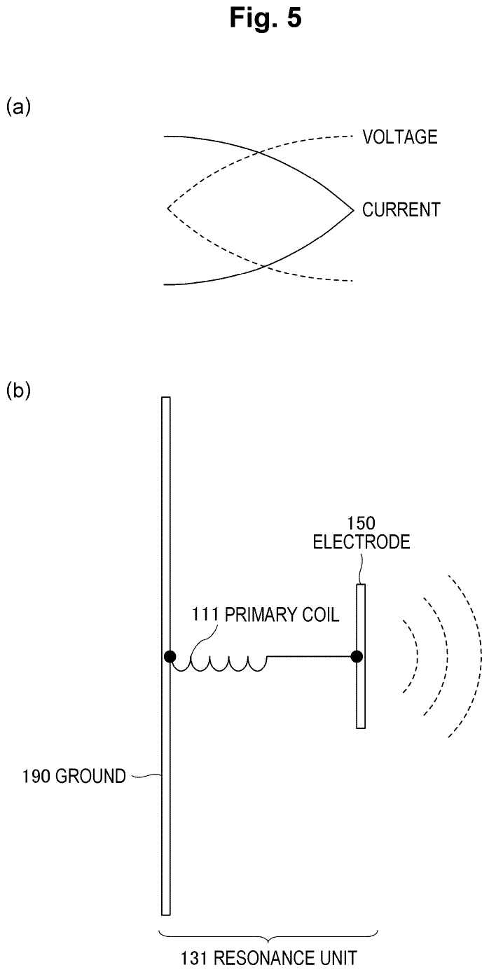

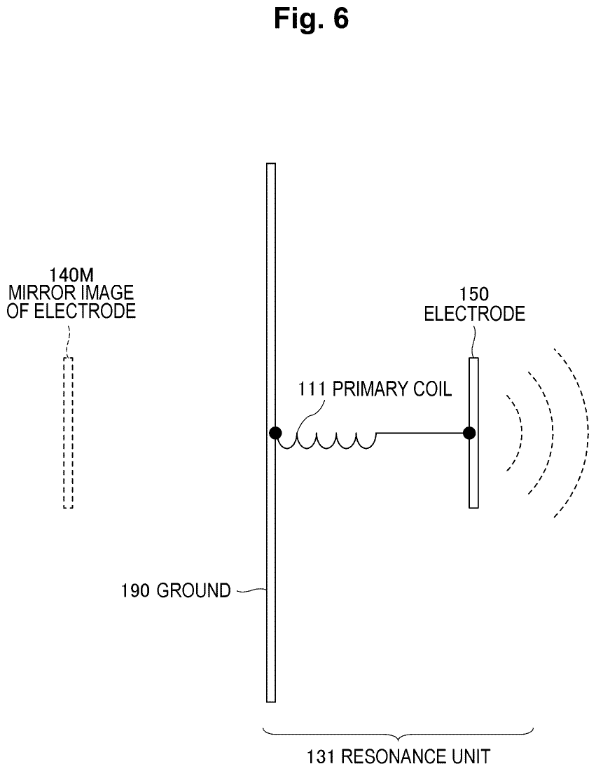

Here, a structure and an operation of a new resonance unit according to the present embodiment will be described with reference to FIG. 5 and FIG. 6. FIG. 5 and FIG. 6 are diagrams illustrating a structure and an operation of a new resonance unit according to the present embodiment.

As illustrated in FIG. 5(b), a new resonance unit 131 in which a primary coil 111 having a half length of the primary coil 110 is used and one end (left end in FIG. 5) of the primary coil is connected to a ground (plate) 190 is considered. A current freely flows through the ground 190, and thus a current amplitude of the standing wave when the resonance unit 131 resonates is a maximum at a connection portion between the primary coil 111 and the ground 190. In addition, since the potential of the ground 190 is always 0, a voltage amplitude of the standing wave is 0 at the connection portion between the primary coil 111 and the ground 190. As a result, as illustrated in FIG. 5(a), standing waves corresponding to a ¼ wavelength are generated in the resonance unit 131. At this time, electric field waves are emitted in the front surface direction of the antenna, that is, from the electrode 150 at the other end (the right end in FIG. 5) toward the air. On the other hand, electric field waves are not generated in the back surface direction of the antenna, that is, on the left side of the ground 190.

Further, the operation of the resonance unit 131 can also be described with reference to FIG. 6. When the ground 190 serves as a mirror and the resonance unit 131 is viewed from the right side of FIG. 6, a micro-electric dipole is formed by the actual electrode 150 that is actually present and a mirror image 140M of the electrode that is projected by the mirror of the ground 190, and electric field waves can be generated in the front surface direction of the antenna, that is, on the right side of the electrode 150. On the other hand, when the resonance unit 131 is viewed from the left side of the ground 190 of FIG. 6, neither the electrode nor the mirror image 140M of the electrode is visible, and thus electric field waves are not generated in the back surface direction of the antenna.

### Power Transmission Device according to Present Embodiment

Next, a power transmission device according to the present embodiment will be described.

### FIRST EMBODIMENT

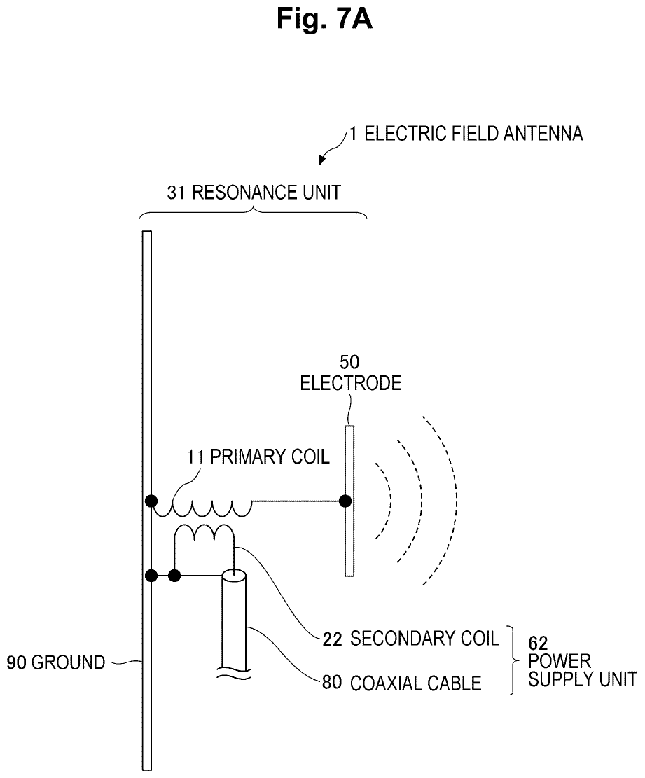

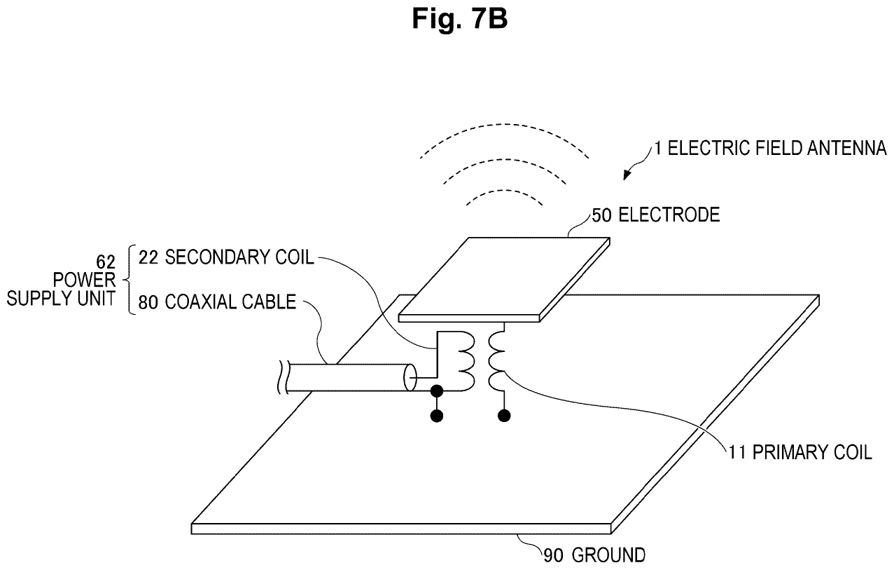

FIG. 7A is a plan view of a power transmission device according to a first embodiment. FIG. 7B is a perspective view of a power transmission device according to a first embodiment.

The electric field antenna using the resonance unit 131 as illustrated in FIG. 5 is realized as illustrated in FIG. 7A and FIG. 7B.

As illustrated in FIG. 7A and FIG. 7B, the power transmission device according to the first embodiment includes an electric field antenna 1. The electric field antenna 1 includes a resonance unit 31 that resonates at a specific frequency, and a power supply unit 62 that inputs power to the resonance unit 31 or extracts power from the resonance unit 31 which resonates.

The resonance unit 31 mainly includes an electrode 50, a ground (plate) 90, and a primary coil 11. The primary coil 11 is electrically connected to the electrode 50 and the ground 90 between the electrode 50 and the ground 90. The electrode 50, the ground 90, and the primary coil 11 respectively correspond to the electrode 150, the ground 190, and the primary coil 111 in FIG. 5. Therefore, a length of the primary coil 11 is half the length of the primary coil 110 in FIG. 4 and FIG. 5.

The power supply unit 62 mainly includes a secondary coil 22 and a coaxial cable 80. The secondary coil 22 is magnetically coupled to the primary coil 11 of the resonance unit 31, and thus power is input and output to and from the resonance unit 31. The coaxial cable 80 is electrically connected to the secondary coil 22, and plays a role of allowing a current to pass to the secondary coil 22 or a current to pass from the secondary coil 22. A side of the coaxial cable 80 opposite to the secondary coil 22 is electrically connected to a power transmission/reception circuit.

That is, by causing the secondary coil 22 of the power supply unit 62 to be magnetically coupled to the primary coil 11 of the resonance unit 31, power is input and output, and by causing the ground of the power supply unit 62 to be connected to the ground 90 of the resonance unit 31, the potentials of the grounds match with each other.

A shape of the electrode 50 is not limited as long as the electrode 50 can play a role of storing charges and generating an electric field in the surroundings. That is, although FIG. 7A and FIG. 7B illustrate an example in which the shape of the electrode 50 is a quadrangle, the shape of the electrode 50 may be a circle. The same applies to a case where a shape of the ground 90 is not limited to a quadrangle. As in a general electric circuit, as an area of the ground 90 is larger, the potential of the ground 90 is less likely to fluctuate and is more stable. Therefore, it is desirable that the ground 90 has a large area.

Since the electrode 50 and the ground 90 are made of a conductor, the electrode 50 and the ground 90 can be made using a board in which a metal foil is attached to a dielectric or a metal plate.

As will be described below, an electric field antenna having a resonance frequency of 13.56 MHz was experimentally produced, and performance of the electric field antenna was compared. In dimensions of the electric field antenna 1 of FIG. 7A and FIG. 7B, for example, an area of the electrode 50 is 100 mm×100 mm, and an area of the ground 90 is 300 mm×300 mm. Both the electrode 50 and the ground 90 were made of a single-sided glass epoxy board having a thickness of 1.6 mm. A distance between the electrode 50 and the ground 90 is 60 mm. The primary coil 11 has a diameter of 10 mm and a length of 46 mm, and the number of turns of the primary coil 11 is 135. The primary coil 11 is made of a conductive wire of which the surface is insulated by polyurethane and which has a thick of 0.32 mm. The secondary coil 22 has a diameter of 11 mm and a length of 10 mm, and the number of turns of the secondary coil 22 is 8. The primary coil 11 is made of a conductive wire of which the surface is insulated by polyurethane and which has a thick of 0.32 mm.

As described above, even in the first embodiment, as illustrated in FIG. 5(a), standing Waves corresponding to a ¼ wavelength are generated in the resonance unit 31. At this time, electric field waves are emitted in the front surface direction of the electric field antenna 1, that is, from the electrode 50 at the other end (the right end in FIG. 7A) toward the air. On the other hand, electric field waves are not generated in the back surface direction of the electric field antenna 1, that is, on the left side of the ground 90.

### Technique as Premise for Second Embodiment and Subsequent Embodiments

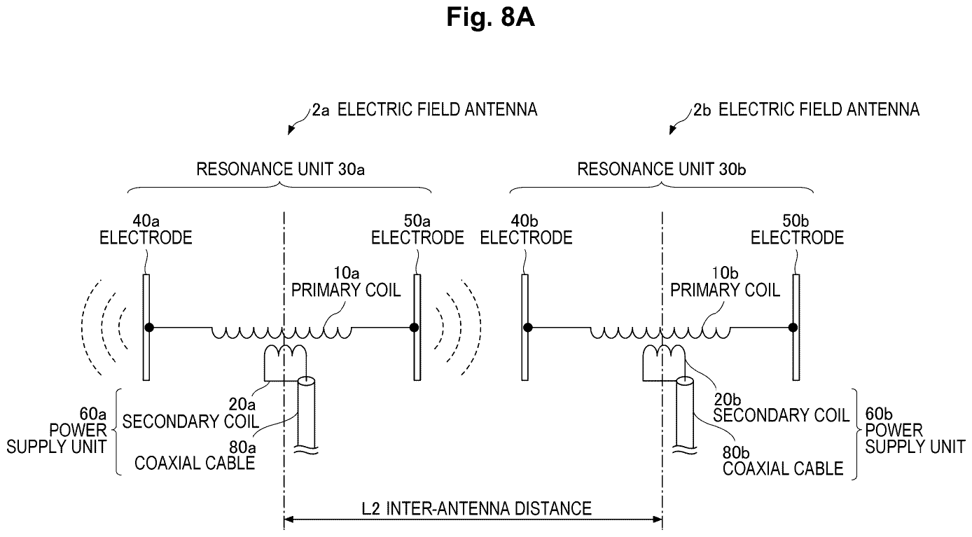

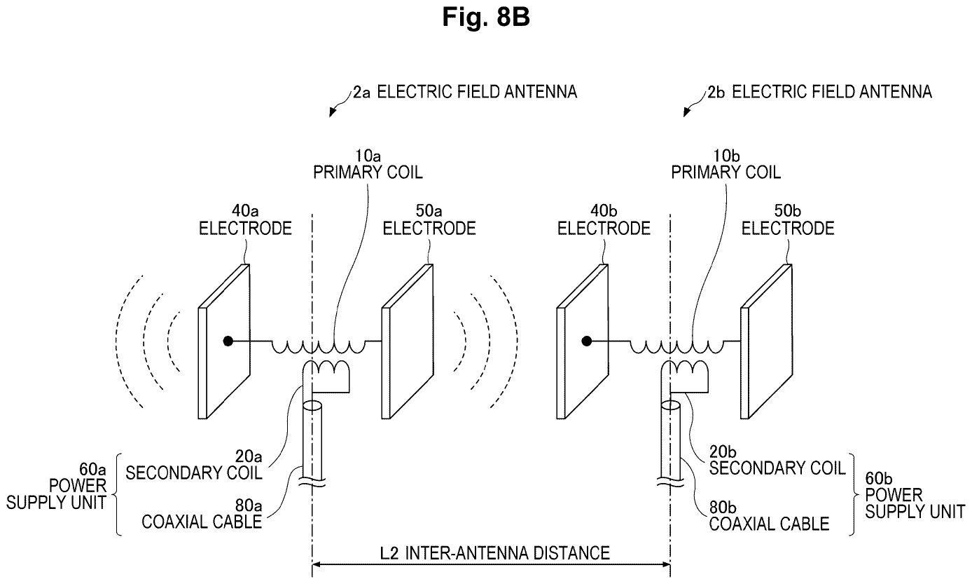

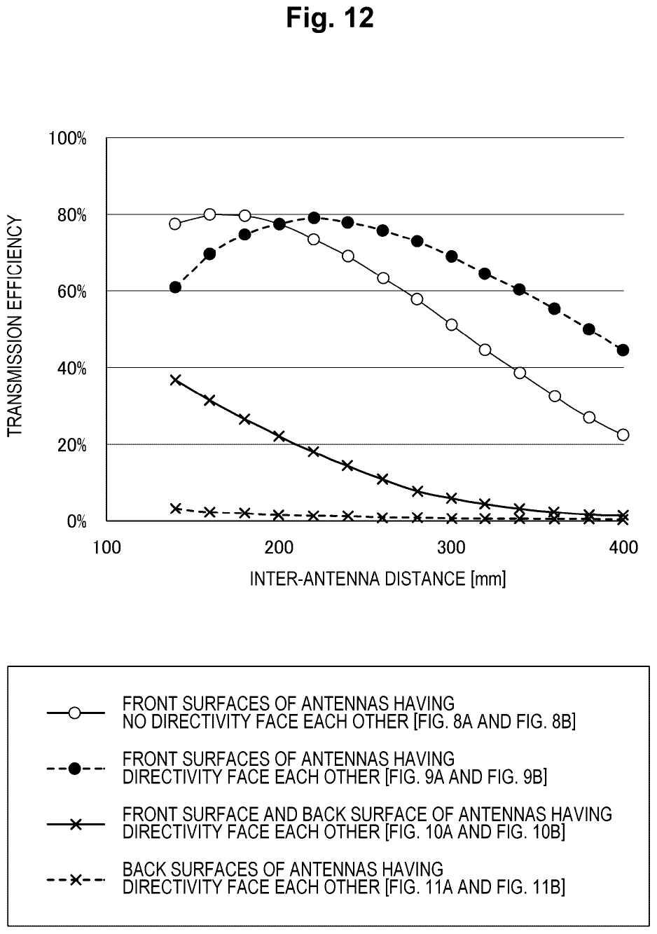

FIG. 8A is a plan view of a power transmission device according to a technique as a premise (hereinafter, referred to as “premise technique”) for a second embodiment and subsequent embodiments. FIG. 8B is a perspective view of a power transmission device according to the premise technique. Note that FIG. 12 is a graph showing transmission efficiency in the premise technique of according to a fourth embodiment.

The power transmission device according to the premise technique includes two (a pair of) electric field antennas 2a and 2b.

Each of the electric field antennas 2a and 2b has the same configuration as the configuration of the electric field antenna 101 of FIG. 3. That is, the primary coils 10a and 10b have the same length as the primary coil 110 in FIG. 4 and FIG. 5, unlike the first embodiment.

The electric field antenna 2a includes a resonance unit 30a that resonates at a specific frequency, and a power supply unit 60a that inputs power to the resonance unit 30a or extracts power from the resonance unit 30a which resonates.

The resonance unit 30a mainly includes an electrode 40a, an electrode 50a, and a primary coil 10a. The electrode 40a, the electrode 50a, and the primary coil 10a respectively correspond to the electrode 140, the electrode 150, and the primary coil 110 in FIG. 3.

The power supply unit 60a mainly includes a secondary coil 20a and a coaxial cable 80a. The secondary coil 20a is magnetically coupled to the primary coil 10a of the resonance unit 30a, and thus power is input and output to and from the resonance unit 30a. The coaxial cable 80a is electrically connected to the secondary coil 20a, and plays a role of allowing a current to pass to the secondary coil 20a or a current to pass from the secondary coil 20a.

Note that the configuration of the electric field antenna 2b is the same as the configuration of the electric field antenna 2a except that the ends of the reference numerals are changed from a to b. Thus, a description of the electric field antenna 2b will be omitted. In addition, a side of the coaxial cable 80a (80b) opposite to the secondary coil 20a (20b) is electrically connected to a power transmission/reception circuit.

As illustrated in FIG. 8A, the power transmission device according to the premise technique is configured such that power emitted by the left electric field antenna 2a is received by the right electric field antenna 2b. Note that, from symmetry of the antenna structure, the electric field antenna 2b may be disposed on a left side of the electric field antenna 2a, and in this case, it is clear that the same transmission efficiency is obtained.

In the dimensions of the electric field antennas 2a and 2b in FIG. 8A and FIG. 8B, for example, each of the electrodes 40a, 40b, 50a, and 50b was made of a single-sided glass epoxy board having an area of 100 mm×100 mm and a thickness of 1.6 mm. A distance between the electrode 40a and the electrode 50a is 120 mm. Similarly, a distance between the electrode 40b and the electrode 50b is 120 mm. The primary coils 10a and 10b have a diameter of 10 mm, a length of 84 mm, and the number of turns of 250, and are made of a conductive wire of which the surface is insulated by polyurethane and which has a thick of 0.32 mm. The secondary coils 20a and 20b have a diameter of 11 mm, a length of 10 mm, and the number of turns of 8, and are made of a conductive wire of which the surface is insulated by polyurethane and which has a thick of 0.32 mm. Note that the transmission efficiency in a case where an inter-antenna distance L2 is changed is illustrated in FIG. 12.

As described above, the power transmission device according to the premise technique illustrated in FIG. 8A and FIG. 8B includes two (a pair of) electric field antennas 2a and 2b. The electric field waves emitted from the electrode 50a of the electric field antenna 2a are absorbed by the electrode 40b of the electric field antenna 2b, and at the same time, the electric field waves emitted from the electrode 40a of the electric field antenna 2a are emitted in the back surface direction opposite to the direction in which the electric field antenna 2b is provided. Therefore, the power transmission device does not have directivity in electric field emission. Based on the technique, second to fourth embodiments obtained by improving the premise technique will be described below.

### SECOND EMBODIMENT

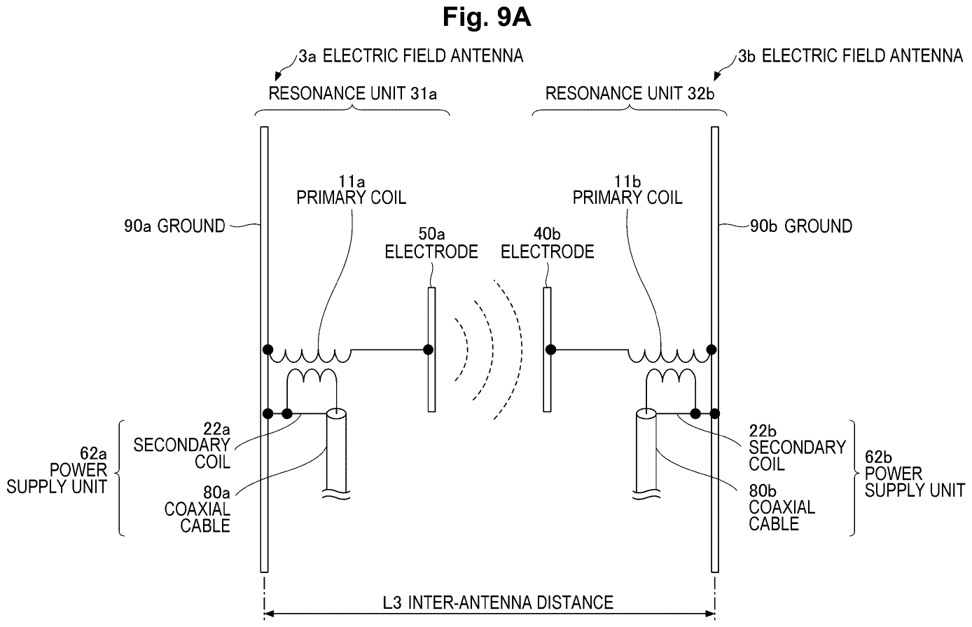

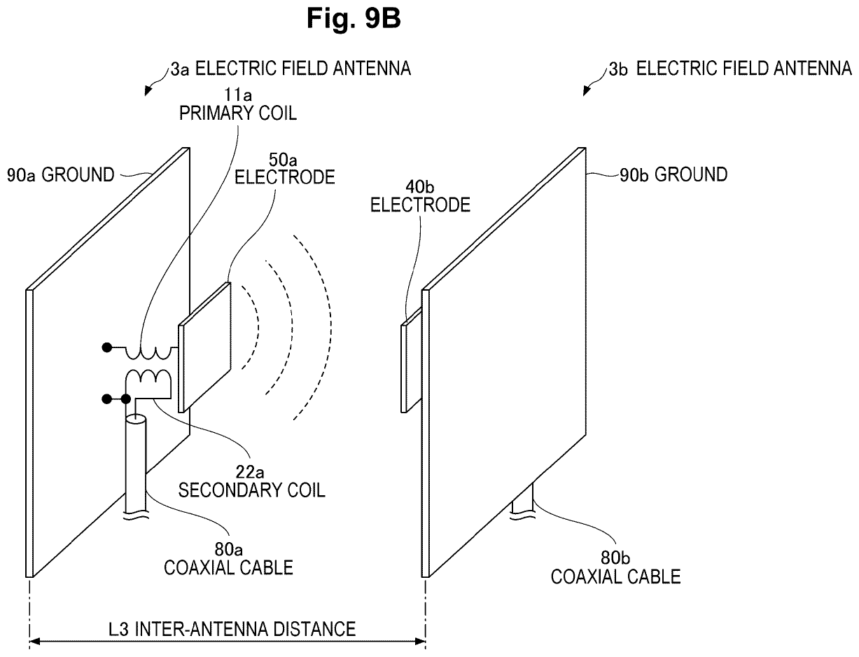

FIG. 9A is a plan view of a power transmission device according to a second embodiment. FIG. 9B is a perspective view of a power transmission device according to a second embodiment.

The power transmission device according to the second embodiment includes two (a pair of) electric field antennas 3a and 3b. In addition, the electrodes 50a and 40b of the electric field antennas 3a and 3b are configured to face each other.

Each of the electric field antennas 3a and 3b has the same configuration as the configuration of the electric field antenna 1 of FIG. 7A and FIG. 7B. That is, as in the first embodiment, a length of each of the primary coils 11a and 11b is half the length of the primary coil 110 in FIG. 4 and FIG. 5.

The electric field antenna 3a includes a resonance unit 31a that resonates at a specific frequency, and a power supply unit 62a that inputs power to the resonance unit 31a or extracts power from the resonance unit 31a which resonates.

The resonance unit 31a mainly includes an electrode 50a, a ground 90a, and a primary coil 11a. The electrode 50a, the ground 90a, and the primary coil 11a respectively correspond to the electrode 50, the ground 90, and the primary coil 11 in FIG. 7A.

The power supply unit 62a mainly includes a secondary coil 22a and a coaxial cable 80a. The secondary coil 22a and the coaxial cable 80a respectively correspond to the secondary coil 22 and the coaxial cable 80 in FIG. 7A.

Note that the configuration of the electric field antenna 3b is the same as the configuration of the electric field antenna 3a except that the ends of the reference numerals are changed from a to b and that left and right sides are reversed. Thus, a description of the electric field antenna 3b will be omitted. In addition, a side of the coaxial cable 80a (80b) opposite to the secondary coil 22a (22b) is electrically connected to a power transmission/reception circuit. The transmission efficiency in a case where an inter-antenna distance L3 is changed is illustrated in FIG. 12.

As illustrated in FIG. 9A and FIG. 9B, in the power transmission device according to the second embodiment, the front surface directions of the electric field antennas 3a and 3b having directivity in emission of electric field waves only in the front surface direction (a direction from the ground to the electrode) face each other. No electric field wave is emitted in the back surface direction (a direction from the electrode to the ground), and power is limited only to the front surface direction. As illustrated in FIG. 12, the second embodiment has an effect that a power transmission distance is longer than a power transmission distance in the premise technique.

### THIRD EMBODIMENT

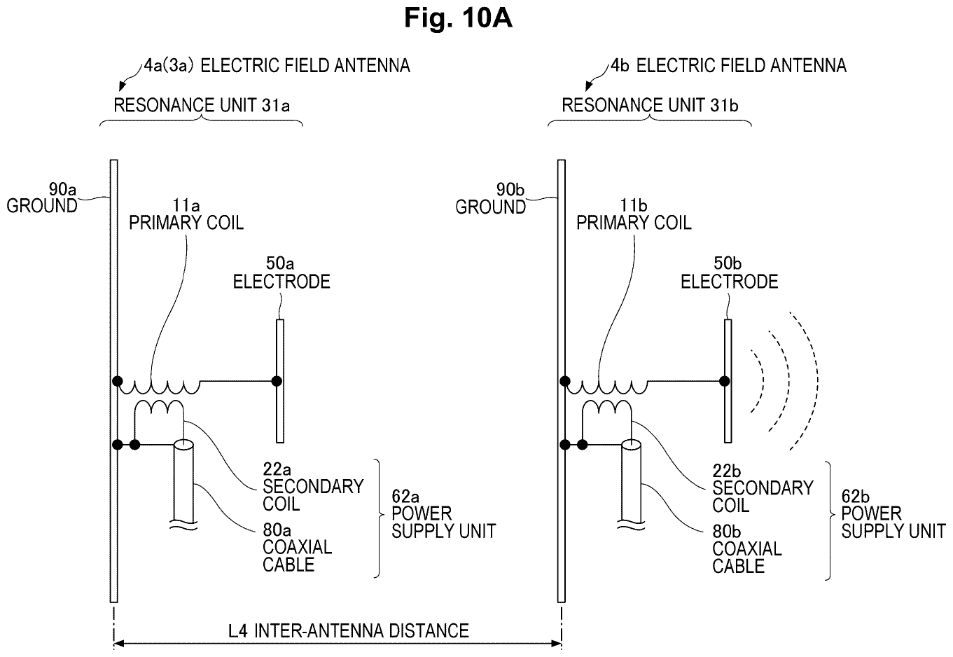

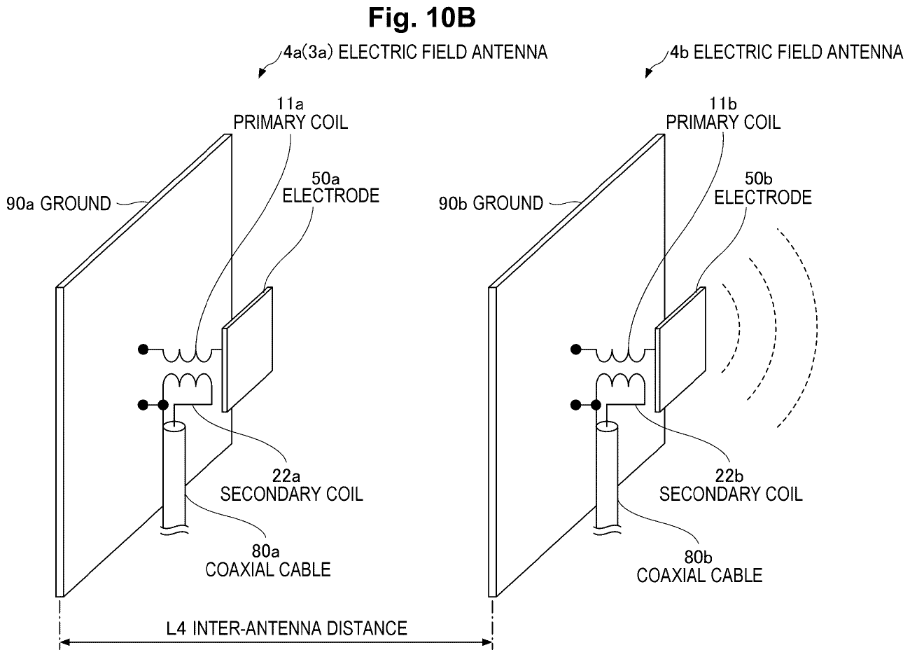

FIG. 10A is a plan view of a power transmission device according to a third embodiment. FIG. 10B is a perspective view of a power transmission device according to a third embodiment.

The power transmission device according to the third embodiment includes two (a pair of) electric field antennas 4a and 4b. In addition, the electrode 50a of one electric field antenna 4a and the ground 90b of another electric field antenna 4b are configured to face each other.

The electric field antenna 4a has the same configuration as the configuration of the electric field antenna 3a in FIG. 9A. Note that the configuration of the electric field antenna 4b is the same as the configuration of the electric field antenna 4a in the same direction except that the ends of the reference numerals are changed from a to b. Thus, a description of the electric field antenna 4b will be omitted. In addition, the transmission efficiency in a case where an inter-antenna distance L4 is changed is illustrated in FIG. 12.

As illustrated in FIG. 10A and FIG. 10B, the power transmission device according to the third embodiment is configured in a state where the electric field antenna 4a for receiving power is brought close to the back surface of the electric field antenna 4b that is transmitting power. No electric field wave is emitted in the back surface direction of the electric field antenna 4b (a direction from the electrode 50b to the ground 90b). In the third embodiment, as illustrated in FIG. 12, the transmission efficiency is lower than the transmission efficiency in the second embodiment in which the front surfaces of the electric field antennas 3a and 3b having directivity face each other.

### FOURTH EMBODIMENT

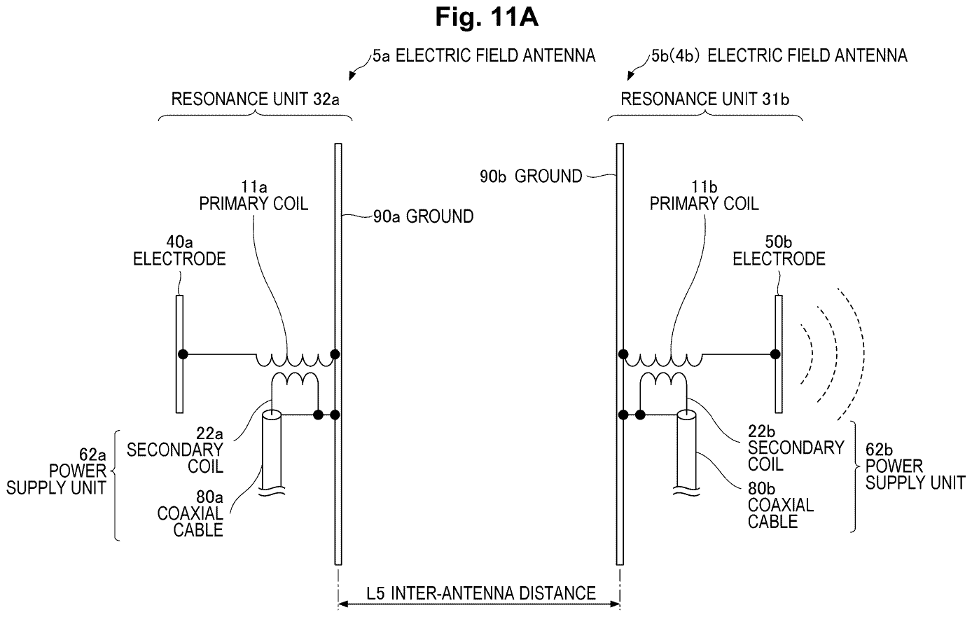

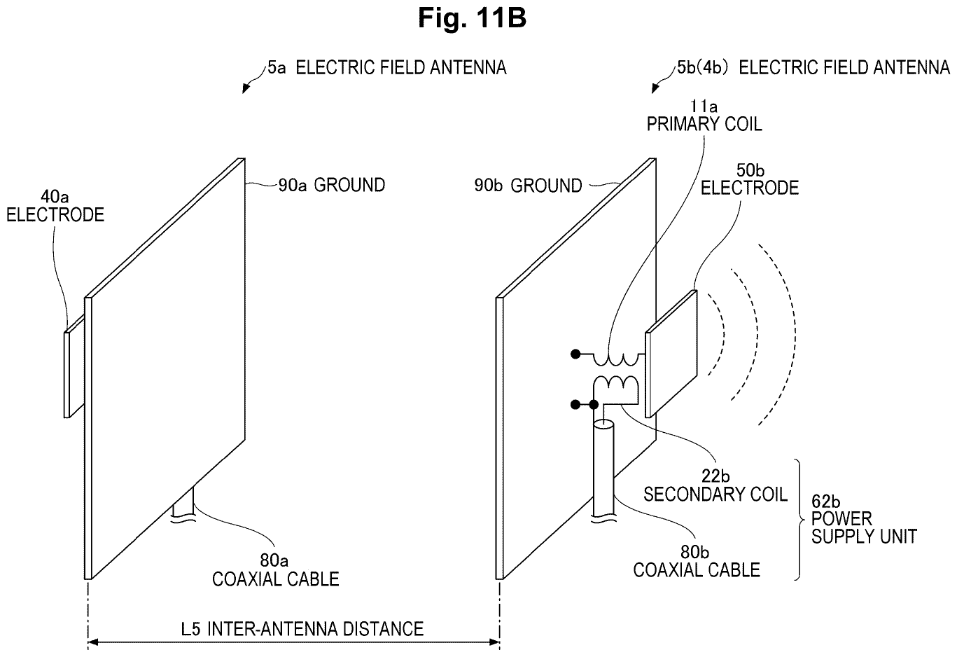

FIG. 11A is a plan view of a power transmission device according to a fourth embodiment. FIG. 11B is a perspective view of a power transmission device according to a fourth embodiment.

The power transmission device according to the fourth embodiment includes two (a pair of) electric field antennas 5a and 5b. In addition, the ground 90a of one electric field antenna 5a and the ground 90b of the other electric field antenna 5b are configured to face each other.

The configuration of the electric field antenna 5a is the same as the configuration of the electric field antenna 3b in FIG. 9A, and the only difference is that the ends of the reference numerals are changed from b to a. The electric field antenna 5b has the same configuration as the configuration of the electric field antenna 4b in FIG. 10A. In addition, the transmission efficiency in a case where an inter-antenna distance L5 is changed is illustrated in FIG. 12.

As illustrated in FIG. 11A and FIG. 11B, the power transmission device according to the fourth embodiment emits electric field waves only in the front surface direction of the electric field antenna 5b (a direction from the ground 90b to the electrode 50b). In the fourth embodiment, since both the electric field antenna 5a and the electric field antenna 5b are in opposite directions, the transmission efficiency is the lowest as illustrated in FIG. 12.

### Summary of Embodiments

As illustrated in FIG. 12, in an antenna using near field resonance of an electric field, there was produced an antenna that emits electric field waves only in the front surface direction, that is, the direction from the ground 90a (90b) to the electrode 50a (50b) (refer to FIG. 9A and FIG. 9B (refer to FIG. 10A and FIG. 10B/Fig. 11A and FIG. 11B) ) and does not emit electric field waves in the back surface direction.

### Main Advantageous Effects of Embodiments

According to the antenna structure of the power transmission device according to each of the embodiments, it is possible to provide an antenna using near field resonance and having directivity that emits electric fields only in the front surface direction in which a counterpart for power transmission or communication is located and does not emit electric fields in the back surface direction opposite to the front surface direction. Thereby, it is possible to realize a wireless power transmission system and a non-contact communication system that have high transmission efficiency, have less influence on external devices, and are less likely to be interfered with by an external environment.

Further, the structure of the resonance unit is half of the structure of the electric field antenna in the related art, and thus it is possible to reduce a size of the antenna, reduce a height of the antenna, reduce the number of parts, and reduce a cost.

### Supplements

The power transmission device according to each of the embodiments can be used in the following applications by using, for example, the antenna of FIG. 9A and FIG. 9B.

(Case 1) Power is wirelessly transmitted from a desk to an electronic device placed on the desk to charge the electronic device.

(Case 2) Power is supplied from the ground surface to an electric vehicle traveling on a road.

(Case 3) Communication and authentication are performed in a case where a user holds a card in front of a non-contact IC card reader.

In many cases, a direction in which a counterpart for power transmission or communication is placed is known in advance.

By providing an antenna using near field resonant that transmits power only in the front surface direction in which the counterpart is present and does not emit electric fields in the back surface direction, it is possible to realize a wireless power transmission system and a non-contact communication system that have high transmission efficiency, have less influence on external devices, and are less likely to be interfered with by an external environment.

### REFERENCE SIGNS LIST

1 Electric field antenna
2a Electric field antenna
2b Electric field antenna
3a Electric field antenna (example of first electric field antenna)
3b Electric field antenna (example of second electric field antenna)
4a Electric field antenna (example of first electric field antenna)
4b Electric field antenna (example of second electric field antenna)
5a Electric field antenna (example of first electric field antenna)
5b Electric field antenna (example of second electric field antenna)
11, 11a, 11b Primary coil
22, 22a, 22b Secondary coil
31, 31a, 31b, 32a, 32b Resonance unit
40a, 40b, 50, 50a, 50b Electrode
62, 62a, 62b Power supply unit
80, 80a, 80b Coaxial cable
90, 90a, 90b Ground
111 Primary coil
131 Resonance unit
150 Electrode
190 Ground

1. A power transmission device that transmits power, the power transmission device comprising:
an electric field antenna including
a resonance unit that includes an electrode, a ground, and a primary coil connecting the electrode and the ground, and resonates at an output frequency of a power transmission/reception circuit for power transmission, and
a power supply unit that includes a secondary coil magnetically coupled to the primary coil and electrically connected to the power transmission/reception circuit, the power supply unit being connected to the ground of the resonance unit and a ground of the power transmission/reception circuit.

2. The power transmission device according to claim 1, wherein
a pair of the electric field antennas are included, and
the electrodes of the pair of the electric field antennas are configured to face each other.

3. The power transmission device according to claim 1, wherein
a pair of the electric field antennas are included, and,
among the pair of the electric field antennas, the electrode of one electric field antenna and the ground of. another electric field antenna are configured to face each other.

4. The power transmission device according to claim 1, wherein
a pair of the electric field antennas are included, and,
among the pair of the electric field antennas, the ground of one electric field antenna and the ground of the other electric field antenna are configured to face each other.
